(19) United States
(12) Patent Application Publication
(10) Pub. No.: US 2015/0239557 A1
(43) Pub. Date: Aug. 27, 2015

(54) Self balancing airborne observational apparatus

(71) Applicant: Jedidya Boros, Ranana (IL)

(72) Inventor: Jedidya Boros, Ranana (IL)

(21) Appl. No.: 13/999,408

(22) Filed: Feb. 25, 2014

(51) Int. Cl. B64C 39/02; B64D 47/00; B60L 9/00; B64D 47/08

(52) U.S. Cl. CPC B64C 39/022; B64C 39/024; B64D 47/08; B64D 47/00; B60L 9/00; B64C 2201/042

(57) ABSTRACT

An airborne observational apparatus is disclosed which is capable of staying in the air for an unlimited period of time. The apparatus includes a ground located, continuous electric power source and an aerial device which is connected permanently to the said power source by a tether cable. The aerial device has a conical shape body. At least one propeller is mounted on the top of the body including at least two rotating blades. The propeller is operated by an electric motor located at the lower part of the said body. The center of gravity of the aerial device will be in its lower part. The tether cable is connected to the aerial device by a preferably U-shaped member on the upper side of the conical body in a pivotal manner. The aerial device has self balancing capability even in strong gusting wind keeping the aerial device in vertical or slightly inclined direction. Photographic or other types of information collecting or broadcasting equipment can be mounted on the aerial device with the capability transferring data to a ground station through the tether cable or radio communication.

### BACKGROUND OF THE INVENTION

This invention relates generally to unmanned airborne devices and more particularly to airborne devices which are operated directly from the surface to collect data and information. Unmanned airborne observational devices are well known, such as airplanes, drones and helicopters; however such conventional airborne observational devices are not entirely satisfactory for a variety of reasons. Two major disadvantages of conventional airborne devices is their limited time duration in the air in addition and their high cost.

Other conventional airborne devices such as balloons have the disadvantage of their large size and cumbersome operation.

Other conventional airborne devices, such as kites have the major disadvantage of being unstable and too sensitive to wind shift. Also they cannot keep their altitude and location for a longer period of time.

Other conventional information collecting devices such as those mounted on poles or high buildings or top of mountains have the major disadvantage of limited ability of information collecting because of their relatively low elevation, resulting in many cases in a limited view of the subjects.

Another major disadvantage of the wireless conventional airborne observational devices is their vulnerability to disturbance and jamming of the data which they transmit.

Another major disadvantage of many unmanned airborne devices in many cases is that the autopilot system cannot evaluate and respond effectively or as fast as required due to the sudden changing wind conditions. As a result, the airborne device can lose its balance and fall out of the sky.

Unmanned airborne observational devices are useful in our daily life for traffic control, forest fire watch, agricultural data collecting, aerial survey and photography and weather forecasting.

### SUMMARY OF THE INVENTION

Accordingly, one objective of the present invention is to provide a new and improved unmanned airborne observational device which overcomes the drawbacks which exist in conventional unmanned airborne observational devices as discussed above.

Another objective of the present invention is to provide a new and improved unmanned airborne observational device which can remain in the air for an unlimited period of time.

Another objective of the present invention is to provide a new and improved unmanned airborne observational device which is automatically self balancing i.e. it can by mechanical means adjust itself to compensate for various wind conditions in order to restore the aerial stability of the device.

A further objective of the present invention is to provide a new and improved unmanned airborne observational device which can be moved from one location to another without retracting the device from the air assuming there are no physical barriers such as electric wires blocking its flight path.

Yet another objective of the present invention is to provide a new and improved unmanned airborne observational device which can carry meteorological and air quality measuring devices and various photo equipment and broadcasting and communication related equipment. Some of this equipment can be gyroscope directed.

Briefly, in accordance with the present invention these and other objectives are attained by providing an unmanned airborne observational device which includes a conical casing. On top of the said casing a lifting apparatus comprising a propeller is attached which is operated by an electric motor located in the lower part of the said casing. The said propeller is made of two or more radially extended blades inclined in circumferential direction in order to produce thrust while it is rotating around a central axis. On the bottom part of the said casing photographic or other information collecting equipment is adapted. Outwardly from the said casing, steady and adjustable wings are attached to compensate for the rotation of the device resulted from the rotation of the propellers. The said electric motor and other equipment is mounted on the self balancing airborne observational device are powered from a ground located power source, which provides a continuous electric power supply directly to the self balancing airborne unlimited duration in the air for the said device. During strong winds, the airborne device can move from its location. According to this embodiment, the self balancing system keeping the balance of the device and as soon as the wind stops, returning it back to its original position. The mechanism of the self balancing system will be explained further in detail.

After liftoff of the self balancing airborne observational device, the tether cable is always in tension as a result of the pulling force produced by the propeller mounted on the top of the self balancing airborne observational device. The required altitude of the said device can be determined by the length of the released tether cable. The airborne device will stay at this height as long as required. The more the tether cable is released the more the airborne device will stay higher. The maximum height the device can reach is determined by the maximum uplift force which the airborne device can produce, the weight of the airborne device, including the weight of the equipment mounted on it and the weight of the released tether cable.

Landing of the airborne device is quite simple. As the propeller of the self balancing airborne observatory device continues its regular operation, the airborne device is pulled back by rolling back the tether cable till the device reaches the landing platform.

The self balancing airborne observational device can be mounted on a ground station structure or on a vehicle or on a towed platform or on a ship.

The present invention represents a new and improved self balancing airborne observatory device capable of an all weather unlimited duration operation. It is reliable, inexpensive, and easy to operate.

### DESCRIPTION OF THE DRAWING

A more complete appreciation of the present invention and many of the attendant advantages thereof will be better understood by referring to the detailed descriptions and the accompanying drawings in which:

FIG. 1a is a perspective view of a self balancing airborne observational device connected to a surface structure according to one embodiment.

FIG. 1b is a perspective view of a self balancing airborne observational device connected to a vehicle according to one embodiment.

FIG. 2 is a cut away perspective view of one embodiment of the self balancing airborne observational device illustrating many of the internal components.

FIG. 3 is a cut away view along axis 1-1, shown on FIG. 1b of one embodiment of the vehicle mounted self balancing airborne observational device illustrating internal components of the vehicle.

FIG. 4 is a front elevation view of the self balancing airborne observational device showing the principles of the self balancing operation during gusting wind or in cases when the towed transport vehicle is moving.

### DESCRIPTION OF THE PREFERRED EMBODIMENTS

Referring now to the drawings wherein like reference characters designate identical or corresponding parts throughout the several views and more particularly to Fig la, the self balancing airborne observational device generally designated 10 is shown during operation in relation to a ground station structure 20 provides power source and landing facility 30 for the self balancing airborne observational device 10. The power source is an electrical grid system, electric generator or batteries generally designated 40. The electric power is transmitted to the self balancing airborne observational device by a tether cable 111. The ground station 20 includes command, control, communication and observational data processing instruments. Because the ground station 20 is capable to provide a continuous power supply to the self balancing airborne observational device, its stay in the air can be continuous and unlimited.

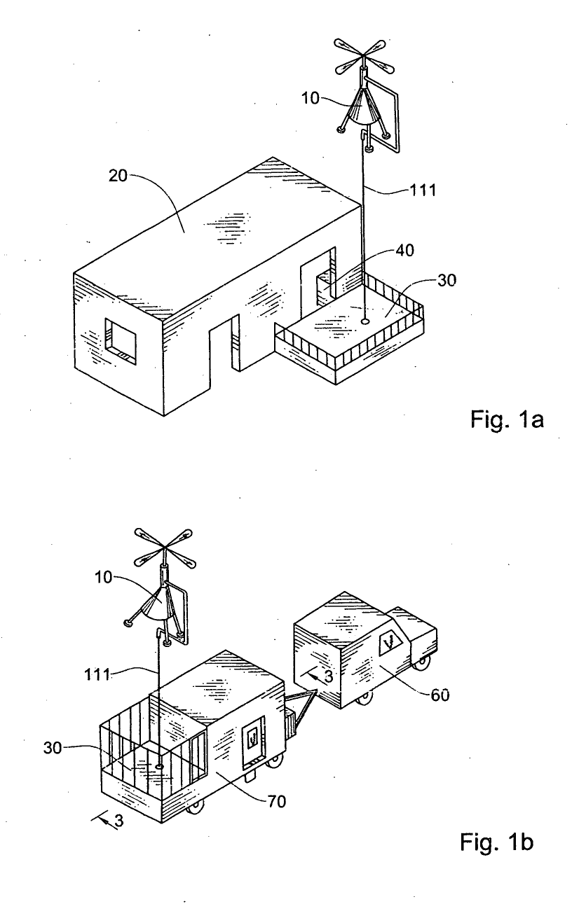

Referring to FIG. 1b, the self balancing airborne observational device 10 is shown during operation in relation to a standing or moving towed transport vehicle designated 70 with a towing vehicle designated 60. In one embodiment the power supply and landing facility is mounted on a towed transport vehicle 70. The power source is an electric generator or an exchangeable or rechargeable battery pack mounted on the towed transport vehicle 70 shown on FIG. 3. In one embodiment the command, control, communication and observational data processing instruments are located in the towed transport vehicle 70. More details are shown on FIG. 3.

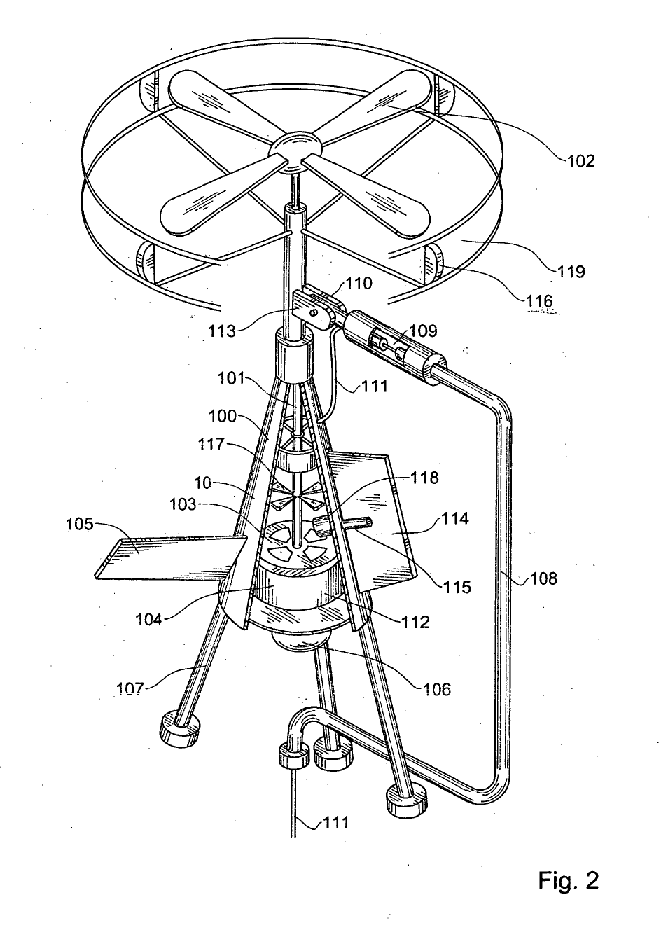

Referring to FIG. 2 it illustrates in more details the self balancing airborne observational device generally designated 10. Including a conical casing 100 into which at the centre of it an elongated rotating shaft is adapted 101. At the top of the said shaft a propeller 102 is attached, at the lower end of the said shaft an electric motor 103 is adapted providing the turning force for the propeller 102. The frame 104 of the said motor 103 is mounted to the said conical casing 100. The said electrical motor is cooled by coaxial mounted fan blades designated 117. Substantially outwardly on the lower part of the said conical casing air foils 105 are mounted in order to compensate the turning moment produced by the said propeller 102. One of the said air foils designated 114 is vertically mounted and pivotably connected to the lower part of the said conical casing and can be turned by a servomotor 118 commanded from the ground around axis 115. This air foil behaves as a stabilizer providing a fine tuning against turning and directing the device against the wind direction.

Inside of the lower part of the said casing 100 various photo and other equipments 106 are mounted. At the lower end of the said casing legs 107 are extended downwardly in order to protect the aerial device in landing.

To the upper part of said conical casing a U shaped pipe 108 is connected which is pivot able in every direction, allowing free movement to the device in any direction.

The U shaped pipe 108 is cut into two parts inside a cylindrical shaft 109 which allows free movement of the aerial device sideways. The pin connected end 110 of the U shaped pipe 108 allows free movement of the aerial device back and forth.

At the lower end of the said U shaped pipe 108 the tether cable 111 is inserted in and connected. The cable contains electrical wires providing power to the airborne device in addition to communication and sensor wires. The upper end of the tether cable is flexibly connected to the motors and instruments of the self balancing airborne observational device.

The center of gravity of the airborne device 112 is located in its lower part. The hanging point 113 is located in the casing upper part. This particular design allows free motion which maintains the airborne device in a vertical position. Even in the case when a heavy wind blows and the tether cable moves in an inclined direction the aerial device soon regains its vertical position.

Around the propeller a protective frame is provided 115, into which preferably blinking indicator lights 116 were installed.

Referring to FIG. 3 in one embodiment the power supply and landing facility 30 is mounted on a towed transport vehicle designated generally 70. The said vehicle 70 includes a base platform 210 to which the wheels 200 are mounted. Above the base platform, a landing platform 220 is mounted. The said platform is surrounded by fence 230 in order to protect the equipment mounted on the vehicle and to protect the self balancing airborne observation device 10 in its position after landing. On the base platform 210 a spool is mounted 231, which can be turned around its horizontal axis backward and forward by an electric motor 232 which is mounted also on the base platform 210. The lower part of the tether cable 111 is spooled on the spool. The said tether cable is leaded through an opening 233 in the landing platform 220 and connected to the self balancing airborne observational vehicle 10. On the base platform 210 where also are mounted an electric generator 234, a fuel tank 235 and an exchangeable or rechargeable battery pack 236.

The U shaped pipe 108 behaves like a handle and helps to direct and locate the self balancing airborne observation device 10 during landing and uplift operations.

Above the spool a rotational length measuring device 237 is mounted on the landing platform 220 in order to measure the length of the released tether cable 111.

In one embodiment the communication, control and image processing room 238 is located on the towed transport vehicle 70. It can include data processing and communication equipment 239 and for convenience an air condition system 240 can be provided.

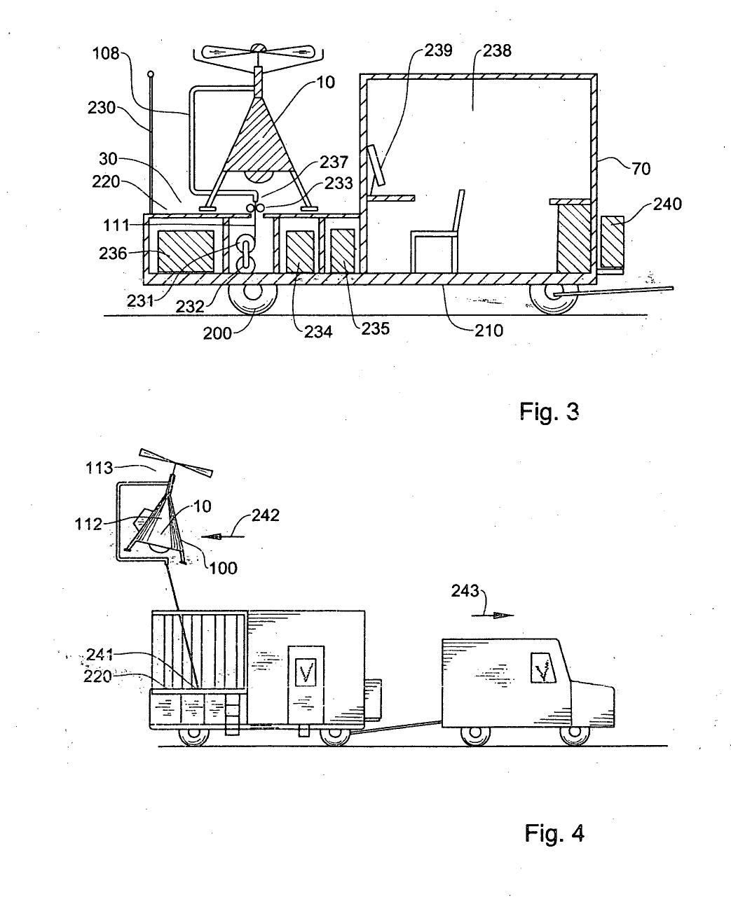

Referring to FIG. 4. As wind gusts, marked by arrow 242, or the vehicle on which the airborne device is mounted moves forward, marked by arrow 243, the self-balancing airborne observational device 10 is pushed backward related to the tether cables connection point 241 to the landing platform 220.

Because the hanging point 113 is close to the upper end of the airborne device and the center of gravity 112 is low, and the airborne device is designed to capable a free turning movement around its hanging point 113 in any direction, the self balancing airborne observational device will keep its original vertical or almost vertical position, therefore the propeller pulling force will remain almost in its vertical direction even in the case when the connecting tether cable is moved into an inclined direction. As soon as the wind stops blowing the airborne device will move along the radius provided by the tether cable to its utmost height, which is above the landing platform. In addition, in accordance with the present invention the conical casing 100 has a larger area in its lower part than its upper part. A gust of wind applies a larger force on the lower part of the said conical casing than on its upper part resulting in a slightly inclined position of the airborne device toward the direction of the wind, which provides additional help to restore the self balancing airborne observational device into its original location above the landing platform.

Obviously, numerous modifications and variations of the present invention are possible in the light of the above teaching. It is therefore to be understood that within the scope of the appended claims, the invention may be practiced otherwise than as specifically disclosed herein. CLAIMS:

What is claimed is:

1. An apparatus comprising:
An airborne observational device comprising at least one propeller.
A ground power supply.
A tether cable transmitting power to the observational device.
A body which is connected above its center of gravity to a ground station by a tether cable.
A connector device bridging between the said body and the tether cable allowing pivot able free movement to the said body.

2. An apparatus according to claim 1 wherein the said body has a conical shape.

3. An apparatus according to claim 1 wherein the connector device is a U shaped pipe member.

4. An apparatus according to claim 1, wherein the tether cable comprises control and information processing wires too.

5. An apparatus according to claim 1, wherein on the surface of the body steady and movable wings are mounted in an inclined direction in order to balance the rotation of the airborne device introduced by the propeller.

6. An apparatus according to claim 1, wherein on the ground a landing facility for the airborne observation device is provided.

7. An apparatus according to claim 1, wherein on the landing facility or below it an electric motor operated spool is mounted on which the tether cable is wound.

8. An apparatus according to claim 1, wherein on this spool or above the spool a measuring device is installed in order to determine the length of the released tether cable.

9. An apparatus according to claim 1, wherein the ground station includes a landing facility an electric power source such as an electric generator, exchangeable or rechargeable battery pack, fuel tank, control room and imaging processing instruments, providing a self containing ground station.

10. An apparatus according to claim 1, wherein the self contained ground station is located in a surface structure.

11. An apparatus according to claim 1, wherein the self containing ground station is mounted on a vehicle.

12. An apparatus according to claim 1, wherein the self containing ground station is mounted on a towed platform.

13. An apparatus according to claim 1, wherein the airborne device is mounted on a ship.

14. An apparatus according to claim 1, wherein the airborne device included at least one camera which is capable to transfer the images through the tether cable to the ground station.

15. An apparatus according to claim 1, wherein the airborne device included at least one camera, which is capable to transfer the images via radio signals to a local or distant control room.

16. An apparatus according to claim 1, wherein the airborne device mounted camera is gyroscope directed.

17. An apparatus according to claim 1, wherein on the airborne device a radio broadcast system and an antenna, or projector lights are installed.

18. An apparatus according to claim 1, wherein the base of the body of the airborne device is triangular, square, or hexagon providing a pyramid shape body.

19. An apparatus according to claim 1, wherein the body of the airborne device has a cylinder or box like shape.
